(19) United States
(12) Patent Application Publication
(10) Pub. No.: US 2019/0344298 A1
(43) Pub. Date: Nov. 14, 2019

(54) PROTECTIVE PLUG

(71) Applicant: DIPOL PLASTIC TECHNOLOGY Sp. z o.o., Jasionka (PL)

(72) Inventors: Sebastian Czarnik, Rzeszow (PL); Pawel Czarnik, Mrowla (PL)

(73) Assignee: DIPOL PLASTIC TECHNOLOGY Sp. z o.o., Jasionka (PL)

(21) Appl. No.: 16/226,792

(22) Filed: Dec. 20, 2018

(30) Foreign Application Priority Data
May 9, 2018 (PL) W.127311

(51) Int. Cl. B05B 12/30; B05B 12/26; B60B 7/02; B60B 7/06

(52) U.S. Cl. CPC B05B 12/30; B60B 7/063; B60B 7/02; B05B 12/26

(57) ABSTRACT

A protective plug characterised because includes a monolithic profile body (1) made of dyed-through polytetrafluoroethylene (PTFE), height H1=10-220 mm, with the lower cylindrical part (2), diameter Ø1=5-100 mm, height H2=1-90 mm, and a part, connected through its upper end, of a spherical layer profile (4), radius R1=5-100 mm, whose upper surface, diameter Ø2=10-110 mm, turns into a shoulder of a low cylinder (5) profile, height H3=0.5-50 mm. The upper round end of the cylindrical part (2) of this plug is connected with the part of the reversed truncated taper (7) profile of analogous diameters Ø1 and Ø2 and the angle of flare a=from 2° to 179.9°, whose upper surface of diameter Ø2 also turns into an analogous low cylinder (5) profile.

### FIELD OF THE INVENTION

The subject of the utility model is a protective plug securing profile holes during painting operations performed on structural elements, in particular car wheel rims, in which screws connecting these painted structural elements and wheel rims with their hubs are inserted.

### BACKGROUND OF THE INVENTION

Wheel rims, in particular the ones made of aluminium, both manufactured in an industrial scale and second-hand ones, require coating with a layer of a material preventing aluminium oxidation by means of the commonly used powder-coating method, due to which it becomes necessary to protect holes in the rims against coating with a layer of such a material, with the view to retaining their original dimensions. Absence of powder used for coating in wheel rim holes ensures that hole dimensions remain unchanged after the powder-coating process, which facilitates fixing the rims in car wheel hubs using inserted screws and also prevents loosening of these screws during car operation, which enhances its use safety.

The Chinese utility model no. CN 202319706U describes a polyvinyl chloride (PVC) plug for car wheel rim holes used to insert screws connecting a rim with a wheel hub and protecting these holes against powder-coating. It comes in a shape of a cylindrical body consisting of the lower cylindrical section with the truncated external lower edge, whose upper end comes with an external horizontal face turning, through the circumferential radius, into the plate-like round part which, on its upper horizontal surface, has an axial shoulder with a truncated cone profile with a rounded vertex located within the symmetry axis and opposite to this bush bottom, fulfilling the function of a handle for this plug, and the external diameter of the lower cylindrical part is adjusted to the diameter of a wheel rim hole secured with this plug.

The Chinese utility model no. CN 204200818U also describes a plug made of polytetrafluoroethylene (PTFE) which protects car wheel rim holes for screws fixing this rim to a car wheel hub, during powder-coating operations. The plug is shaped as a profile body comprising: a lower bushing-like part of an outside diameter larger by 2 to 3 mm than the diameter of the hole in which it is seated, an element of a reversed truncated taper shape adjoining the upper end of this bushing to whose upper horizontal surface a cylindrical element of diameter larger by 4-5 mm than the diameter of the upper surface of the truncated taper adjoins, and, in the symmetry axis of these components, an elongated element of a truncated taper profile protrudes upward from the surface of the upper cylindrical element to act as a handle while seating the bushing part in a protected hole and removing it from this hole, after the powder-coating of a car wheel rim is completed.

The Polish utility model no. PL67831 also describes a protective plug used to protect holes in structural elements coated with anti-corrosion materials, in particular car wheel rims coated with these materials, which comes with the lower cylindrical fixing part terminated with a flange mounting of a reversed truncated taper profile whose bottom is connected with a handle. The plug handle comprises a flat element located on the upper surface of the part fixing the plug in the protected hole, of the rectangle profile tapered upwards, at the “a” angle that should be equal to 1°, whose length is at least 70 mm and it width at the base is at least 10 mm, its thickness is 6 mm, but, in its upper part, the thickness of this flat element is at least 2 mm and its length should be 20 mm.

### SUMMARY OF THE INVENTION

The objective of the utility model is to design a universal, simple and coherent structure of a protective plug enabling it to be mounted in protected holes having round profiles with both spherical and tapered entries.

The objective of the utility model is also to create this universal plug from a material which will make it possible to assess its usability period in industrial conditions as well as determine the number of wheel rims coated using such plugs and determine the degree of their wear and necessity to decommission them.

A protective plug securing, during car wheel rim painting operations, the profile holes in which screws connecting these structural elements, in particular the elements fixing a painted car wheel rim to the wheel hub, made of polytetrafluoroethylene (PTFE), in a shape of a monolithic profile body with a two-part profile element of dimensions adjusted to diameters of holes and profiles of seats connected with them and provided in car wheel rims, according to the utility model, is characterised by the fact that it comprises the following elements:

i. a monolithic profile body made of dyed-through polytetrafluoroethylene (PTFE), height H1=10-220 mm, consisting of the lower cylindrical part, diameter Ø1=5-100 mm, height H2=1-90 mm, and a part, connected through its upper end, of a spherical layer profile, radius R1=5-100 mm, whose upper surface, diameter Ø2=10-110 mm, turns into a shoulder of a low cylinder profile, height H3=0.5-50 mm; moreover,
ii. a beneficial solution is that, in the plug, the upper round end of the cylindrical part is connected with the part of the reversed truncated taper profile of analogous diameters Ø1 and Ø2 and the angle of flare a=from 2° to 179.9°, whose upper surface of diameter Ø2 also turns into an analogous low cylinder profile, and the cylindrical part comes with its lower edge truncated.

Moreover, a solution in which the edges of the upper surfaces of the spherical and tapered profile are rounded, but not provided with low cylindrical shoulders, is also beneficial.

According to the utility model, the protective plug has a much simpler and material-saving design, which makes it easy to construct, lowers its manufacturing costs and meets all applicable tightness requirements after inserting it in a powder-coated wheel rim hole.

The material used, i.e. polytetrafluoroethylene (PTFE), facilitates extension of the plug life and makes it possible to use it during the entire powder-coating process as well as during the polymerisation (soaking) process, i.e. creating a paint coat in a furnace, which in turn makes it possible to obtain high quality parameters of the paint coat obtained, which prevents its chipping while tightening a rim to a wheel hub, also eliminating the hazard caused by loosening a screw during car operation.

Moreover, the fact that the plug is made of dyed-through polytetrafluoroethylene (PTFE) enables its users to assess its usage time on a production line performing the process of powder-coating of car wheel rims equipped with these plugs and to assess the number of times these plugs are inserted in the profile holes of these rims. After a series of wheel rims is coated, the plugs are removed from them and washed (cleaned) and polished, as a result of which, after multiple polishing processes, they can become scratched in a manner compromising their tightness. Then, a user having information regarding their usability period and number of wheel rims coated using these plugs is able to take an informed decision on replacing the entire batch of plugs in a given colour and start powder-coating by means of new plugs, preferably in a different colour.

### BRIEF DESCRIPTION OF THE FIGURES

FIG. 1 shows a front view of the protective plug according to the present invention to be inserted in a round hole with a spherical entry (seat);

FIG. 2 shows a front view of a modified protective plug to be inserted in a round hole with a tapered entry (seat); and

FIG. 3 shows a cross sectional view of a car wheel hub in a vertical section, with a cylindrical-spherical plug of the same profile seated in its hole.

### DETAILED DESCRIPTION OF THE INVENTION

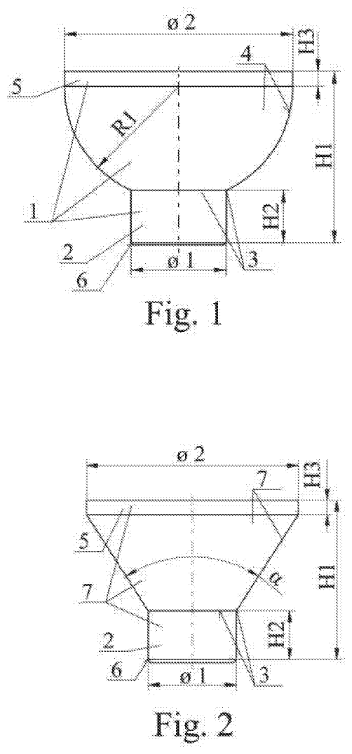

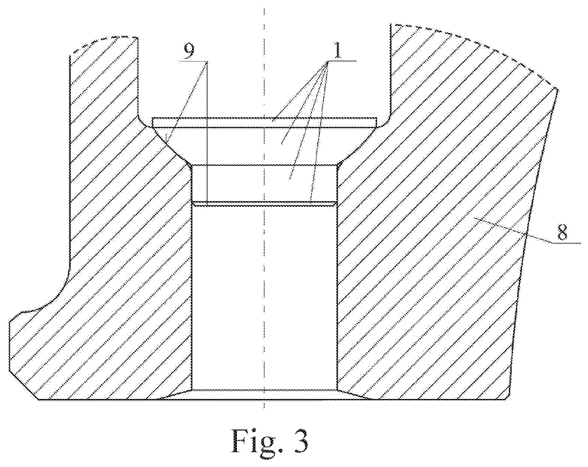

The subject of the utility model is shown in FIG. 1-3, where FIG. 1 shows a protective plug to be inserted in a round hole with a spherical entry (seat), in a front view, FIG. 2 shows a modified protective plug to be inserted in a round hole with a tapered entry (seat), and FIG. 3 shows a cross sectional view of a car wheel hub in a vertical section, with a cylindrical-spherical plug of the same profile seated in its hole.

As shown in FIG. 1, the protective plug designed to be inserted in cylindrical-spherical holes of car wheel rims is made of dyed-through polytetrafluoroethylene (PTFE), in a shape of a monolithic profile body (1), height H1=10 mm, comprising the lower cylindrical part (2), height H2=1 mm, diameter Ø1=5 mm, whose round end (3) turns into a part of a spherical layer profile (4), radius R1=5 mm, upper diameter θ2=10 mm, with a shoulder of a low cylinder profile (5) of the same diameter Ø2 and height H3=0.5 mm, and the lower end of the cylindrical part (2) has a truncated edge (6).

The modified form of the plug adapted to be seated in cylindrical-tapered holes in car wheel rims, as shown in FIG. 2, is also made of dyed-through polytetrafluoroethylene (PTFE), in a shape of a monolithic profile body (1), height H1=10 mm, also comprising the lower cylindrical part (2), height H2=1 mm, diameter Ø1=5 mm, whose round end (3) turns into a part of a reversed truncated taper profile (7), angle of flare □=60°, upper diameter Ø2=10 mm, with a shoulder of a low cylinder profile (5) of the same diameter Ø2 and height H3=0.5 mm, and the lower end of the cylindrical part (2) also has a truncated edge (6), which facilitates inserting it in holes of powder-coated wheels.

Other modified forms of plugs, as shown in FIGS. 1 and 2, feature cylindrical parts (2) of height H2=90 mm and diameters Ø1=100 mm, spherical layer radii R1=100 mm, and the upper diameters for both the spherical layer (4) and truncated taper (7) are Ø2=110 mm, however, their cylindrical shoulders' (5) height is H3=50 mm, or the upper layers of the spherical layer (4) and truncated taper (7) have rounded parts of radius length 0.2-1 mm (not shown in the Figure) and the angle of flare value (“a”) of the tapered part (7) is from 2° to 179.9° while the maximum height of plugs H1=220 mm. According to the utility model, dimensions Ø1, Ø2, H1, H2, R1 and dimensions of “a” angles are adjusted to dimensions of holes with spherical and/or tapered seats in powder-coated wheel rims in which fixing screws of the same profiles are inserted to mount these rims on wheel hubs (not shown in the Figure).

FIG. 3 shows a fragment of a wheel rim (8) with a cylindrical-spherical hole (9) with a seated protective plug (1) of the same profile as the wheel rim hole. This plug protects the surface of this hole against covering it with a coat of paint during the powder-coating process.

According to the utility model, the plugs are made of polytetrafluoroethylene (PTFE) dyed-through in the following colours: blue, orange, green, yellow, purple, grey, black, red and pink.

1. A protective plug to secure during powder-coating operations of a car wheel rim holes and other structural elements in which screws connecting painted structural elements and wheel rims with hubs are inserted, the protective plug comprising:
a monolithic profile body made of a dyed-through polytetrafluoroethylene (PTFE) having dimensions adjusted to diameters of holes and seats connected to the protective plug, with a height H1=10-220 mm, the monolithic profile body having:
a lower cylindrical part (2) having a diameter Ø1=5-100 mm, a height H2=1-90 mm, and
an upper a part connected to the lower cylindrical part (2), the upper part including a spherical shape (4), a radius R1=5-100 mm, an upper surface, a diameter Ø2=10-110 mm, the upper surface turns into a shoulder of a low cylinder (5) profile, with a height H3=0.5-50 mm.

2. The protective plug according to claim 1, wherein the protective plug the upper part of the lower cylindrical part (2) is connected with a part having reversed truncated taper (7) shape of analogous diameters Ø1 and Ø2 and the angle of flare a=from 2° to 179.9°, whose upper surface of diameter Ø2 also turns into an analogous low cylinder (5) profile.

3. The protective plug according to claim 1, wherein cylindrical part (2) has a truncated lower edge (6).

4. The protective plug According to claim 3, wherein the edges are rounded.
